(19) United States
(12) Patent Application Publication
(10) Pub. No.: US 2010/0082644 A1
(43) Pub. Date: Apr. 1, 2010

(54) IMPLICIT INFORMATION ON MEDIA FROM USER ACTIONS

(75) Inventors: Muy-Chu Ly, Palaiseau (FR); Alexis Germaneau, Nanterre (FR); Erwan Baynaud, Paris (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent USA Inc.

(21) Appl. No.: 12/367,704

(22) Filed: Feb. 9, 2009

Related U.S. Application Data
(60) Provisional application No. 61/100,554, filed on Sep. 26, 2008.

(51) Int. Cl. G06F 17/30

(52) U.S. Cl. 707/751; 707/E17.005; 707/E17.009; 707/E17.032

(57) ABSTRACT

The exemplary embodiments relate to a new interactive method and system to implicitly enrich any multimedia content effortlessly by combining multiple pieces of information on media content. The new solution consists of logging implicit user actions (e.g., display, modify, remove, copy, classify, send) on media from their terminals (e.g., PC, mobile phone, PDA). Pertinent information related to media will be then statistically generated and consolidated from these logged media actions and will be used to enrich related media content. A unique identifier number will be associated with each media in order to retrieve its associated information.

### BACKGROUND OF THE INVENTION

The present invention relates to a method and apparatus for adding implicit information to media based on user actions. While the invention is particularly directed to the art of telecommunications, and will be thus described with specific reference thereto, it will be appreciated that the invention may have usefulness in other fields and applications.

By way of background, electronic media includes text, audio, still images, animation, and video. Multimedia refers to media and content that utilizes a combination of media content forms. Such media is usually recorded and played, displayed or accessed by information content processing devices, such as computerized and electronic devices. These devices may include, for example, mobile telephones, laptops, personal computers, video game consoles, and personal digital assistants.

In ever increasing numbers, users manipulate, that is, they display, review, modify, remove, classify, copy, move, and send, electronic media with their electronic devices. Such growth has been fueled, at least in part, by social networks like Flickr/Facebook, peer-to-peer platforms like eMule/eDonkey, and media portals like Picasa/YouTube.

Because of the increase in media content, it has become more difficult to have pertinent information related to a given media when needed. Users may wish to retrieve pertinent information related to media with less effort and without explicitly giving information on it.

Thus, media content may be enriched with additional information—usually called “metadata” (data describing media content). It can be the title of the content, the title of a particular scene at a given time, the names of the singers or of the actors, just to name a few. Many users are often doing local actions adding some context to media contents. The problem is that media content can be duplicated a number of times across the globe and on millions of electronic devices, and, in doing so, information describing this content that has been explicitly (e.g., tags, comments, etc.) or implicitly (e.g., archive name, filename, etc.) enriched by the users independently is typically not combined and retrieved together.

One known solution to this problem is the International Standard Audiovisual Number (ISAN), which is a voluntary numbering system for the identification of audiovisual works. ISAN provides a unique, internationally recognized and permanent reference number for each work and their derivatives. ISAN identifies works throughout their entire life and is independent of any physical form in which the work exists or is distributed. An ISAN provides the foundation for electronic exchange of information about audiovisual works, such as motion picture films, television productions, Internet media, and games. It is the key identifier for commerce surrounding finished works. Applications include basic archive identification, rights management, royalty management, television program guide linking, and audience measurement.

There are other related identifiers in use today in media, including the following:
Advertising Digital Identifier (Ad-ID), which is used for all forms of advertising
International Standard Book Number (ISBN), which is used for printed works
International Standard Recording Code (ISRC), which is used for sound recordings such as CDs
Unique Material Identifier (UMID), which is used for production and post-production work in process and typically used within closely-related community

These other identifiers, while all unique, do not have a public central registry and all the benefits that ISAN provides.

The best existing solution (ISAN) is limited because it is not for print media (IBSN), audio-only works (ISRC), or unpublished production material (UMID). ISAN is only for works with moving pictures, or parts directly related to works with moving pictures (such as a full audio track of a feature film). ISAN is for finished works and exchange between potentially unrelated commercial entities. ISAN information should be explicitly provided by author or experts. The ISAN database only contains institutional information such as title, original language, alternate title(s), title(s) of other language version, year of reference, year of first publication, full name of main producer, and the main production company.

Thus, there is a need for solution that solves the above-mentioned difficulties and others.

### SUMMARY OF THE INVENTION

The exemplary embodiments relate to a new interactive method and system to implicitly enrich any multimedia content effortlessly by combining multiple pieces of information on media content. The new solution consists of logging implicit user actions (e.g., display, modify, remove, copy, classify, send) on media from their terminals (e.g., PC, mobile phone, PDA). Pertinent information related to media will be then statistically generated and consolidated from these logged media actions and will be used to enrich related media content. A unique identifier number will be associated with each media in order to retrieve its associated information.

In accordance with an aspect of the present invention, an apparatus for tracking and correlating user actions on electronic media in a telecommunications network is provided. The apparatus comprises: a media action logs database that stores all media action logs related to any media received from a client via a telecommunications device; a consolidation engine that correlates according to statistical criteria implicit user actions on media to extract information associated with a given media; a media information database that stores all media enriched by pertinent information resulting from the consolidation engine, wherein each stored media can be retrieved with a unique identifier number; and at least one application server that can access and enrich information related to media stored in the media information database.

In accordance with another aspect of the present invention, a method of tracking and correlating user actions on electronic media via a media action data server in a telecommunications network is provided. The method comprises: collecting media action logs received from a client; storing all user action logs related to any media received from the client in a media action logs database; correlating according to statistical criteria implicit user actions on media to extract information associated with a given media; storing all media enriched by pertinent information resulting from the consolidation engine in a media information database, wherein each stored media can be retrieved with a unique identifier number; and managing media resulting from the consolidation engine.

In accordance with yet another aspect of the present invention, a computer program product is provided. The computer program product comprises: a computer-usable data carrier storing instructions that, when executed by a computer in a telecommunications network, cause the computer to perform a method comprising: collecting media action logs received from a client; storing all user action logs related to any media received from the client in a media action logs database; correlating according to statistical criteria implicit user actions on media to extract information associated with a given media; storing all media enriched by pertinent information resulting from the consolidation engine in a media information database, wherein each stored media can be retrieved with a unique identifier number; and managing media resulting from the consolidation engine

In accordance with yet another aspect of the invention, a media ID card for centralizing all pertinent information related to a media is provided. The media ID card includes enriched information obtained from a consolidation engine that collects descriptive metadata and a history of implicit actions performed on the media by users and a plurality of links with other media and users.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth and illustrated in the accompanying drawings in which:

FIG. 1 is an overview of the architecture according to the presently described embodiments;

FIG. 2 is a detailed view of the architecture according to the presently described embodiments;

FIG. 3 is an example of a statistical correlation matrix from the consolidation matrix;

FIG. 4 is a media usage model;

FIG. 5 is an example of a media usage instantiation; and

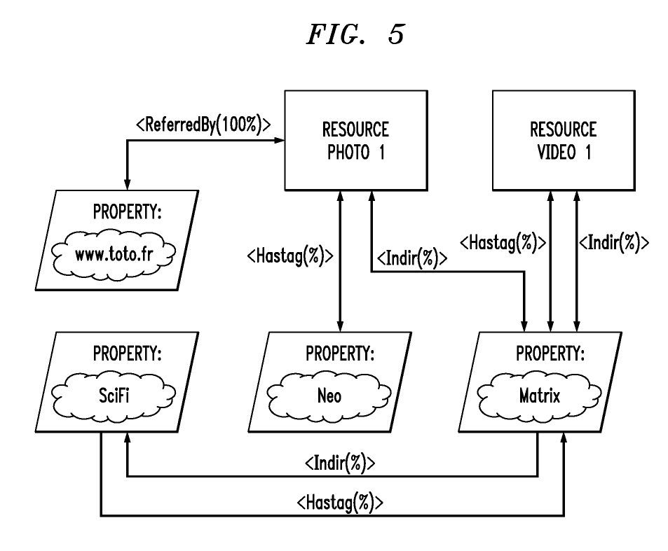

FIG. 6 is a vector similarity graph.

### DETAILED DESCRIPTION

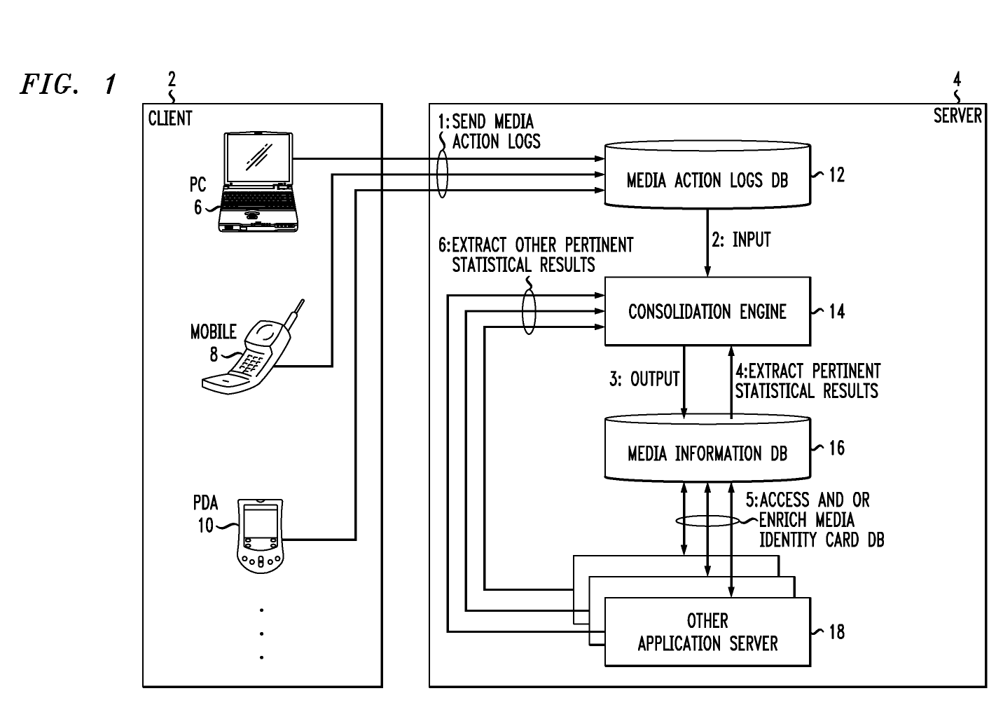

Referring now to the drawings wherein the showings are for purposes of illustrating the exemplary embodiments only and not for purposes of limiting the claimed subject matter, FIG. 1 provides a view of an exemplary service architecture within a telecommunication network into which the presently described embodiments may be incorporated. The service architecture includes at least one client 2 and at least one media action data server 4.

The client 2 may use one or more types of electronic devices such as a laptop or personal computer (PC) 6, a mobile phone 8 or a personal digital assistant (PDA) 10. Such devices are capable of manipulating various types of media and communicating with the media action data server 4 via the telecommunication network.

The media action data server 4 may include a media action logs database 12, a consolidation engine 14, a media information database 16, and other application server(s) 18. The media action data server 4 may be implemented in an existing server in the telecommunication network or may be implemented in a stand-alone server.

The media action logs database 12 stores all user action logs related to any media from the client 2 via the PC 6, the mobile phone 8 and/or the PDA 10).

The consolidation engine 14 correlates (according to some statistical criteria) implicit user actions on media in order to extract some pertinent information (for example, annotations, categories, usage of the media, etc.) associated with a given media and generates a media ID card for the media. This component will be discussed in greater detail later.

The media information database 16 stores all media enriched by pertinent information (resulting from the consolidation engine 14). Each stored media can be retrieved with its unique identifier number.

The other application servers 18 can also access and enrich pertinent information related to media stored in media information database 16. Some application servers can also directly exploit specific consolidated results from the consolidation engine 14 in order to enrich the media information database 16.

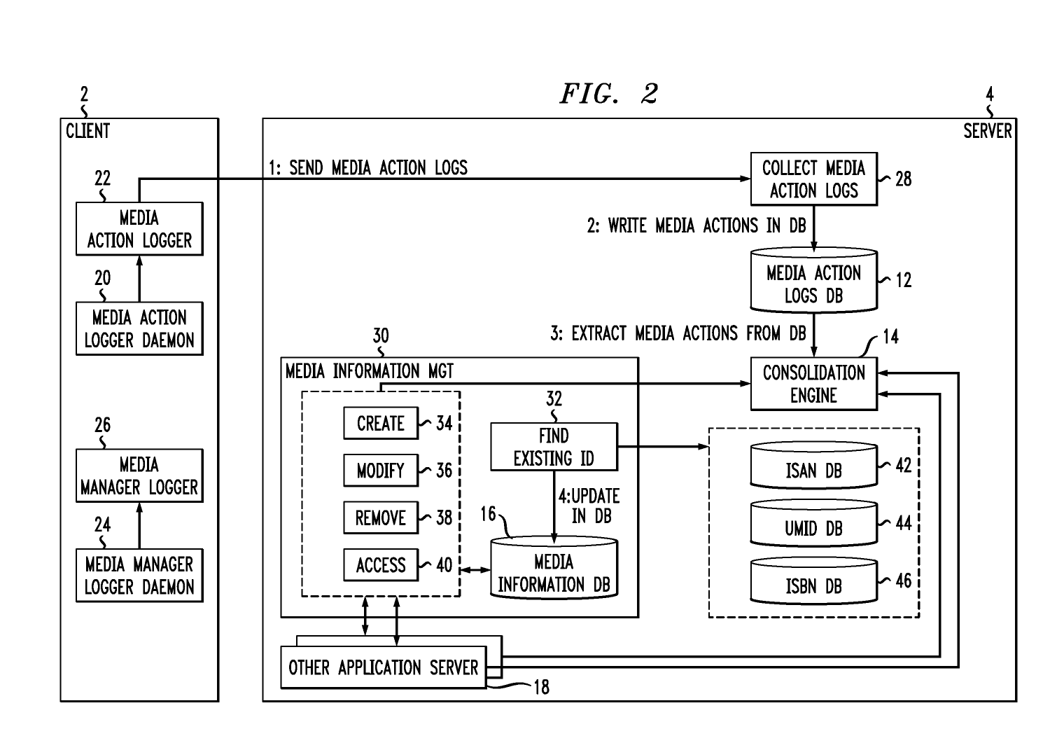

Referring now to FIG. 2, which represents a detailed view of the service architecture, the client 2 may include several additional functions. For example, a media action logger daemon 20 catches user actions performed on media via the various terminals (6, 8, and 10) at the client side. Media actions are logged and managed by a media action logger 22. The non-exhaustive list of implicit user actions on media includes the following: download, upload, store, send, copy, move, modify, display, URL association.

A media manager logger daemon 24 catches the media manipulations of the user on their electronic device. Media is logged separately from its header (i.e., only the real media content and not any additional information) in order to be independent from the media format/structure. They are managed by a media manager logger 26.

With respect to the server 4, there are several additional functions, as shown in FIG. 2. For example, a collect media action logs component 28 collects all media action logs from the client 2. These media action logs are stored in the media action logs database 12. A media action log may include, for example, a resource unique ID, a resource type, an external resource unique ID, a log type, and/or a log value.

Resource unique ID (example: MD5 Hash code . . . ): In the context of the current invention, the resource unique ID identifies the resource seen by the end user (e.g., a file). It is assumed this identifier is independent of metadata associated to the resource. For instance in an “.avi” it can be calculated by hash coding of useful bytes of the file independently of the headers that contains information about files (authors, movie title, etc.). An advantage of calculating unique identifier based on files is the ability to track widely usage of the content. A drawback is the sensibility of that method to the modification of file format (e.g., encoding a video from MPEG4 to XVID) and can lead to the loss of relationships with institutional identifiers (e.g., ISAN for videos). But the association between institutional identifiers and the file can be reconstituted a posteriori by the consolidation engine 14 described above.

Resource type: This defines the type of media (video, photo, document) according to its filename extension (.avi, .jpg, .doc, .pdf).

External Resource unique ID: The media can be associated to an institutional identifier ID according to the media type (for example: IBSN identifier for a print media, ISAN identifier for a moving picture, ISRC identifier for an audio media).

Log type: The type of action can be identified (example: download, upload, URL, file system information, embedded metadata).

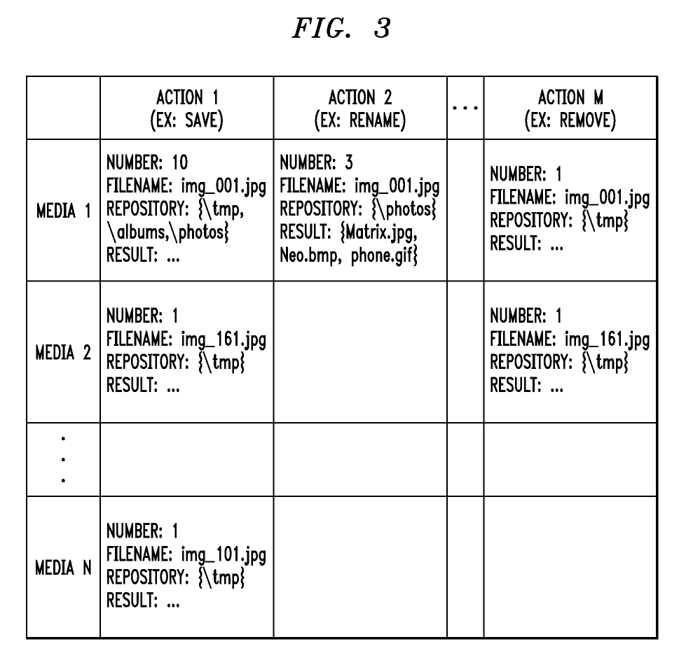

The consolidation engine 14 enables correlating user actions with media in order to give pertinent information on a media by applying some statistical correlation criteria. FIG. 3 shows an example of a statistical correlation matrix from the consolidation engine 14. Set forth below is a non-exhaustive list of statistical correlation criteria:
Different action types (e.g., download, display, copy) related to a given media
Total number of an execution action for a given media
Filename of the media when it is copied/renamed/downloaded by users
Repository name where media is stored/copied/moved
Explicit comments, such as tags on media by users
Implicit/explicit association(s) with other media
Annotation on media via the other Application Servers 18
Total or partial visualization of media
Copy or visualization number of media

A media information management component 30 manages media resulting from the consolidation engine 14. Each media is managed as a unique entity or identity that contains enriched information/metadata. For each media, several functions are possible, including, but not limited to, a find existing ID function 32, a “create” function 34, a “modify” function 36, a “remove” function 38, and an “access” function 40. The media is stored with a unique internal identifier in the media information database 16.

The related media type can be also stored in the media information database 16. According to the media type (e.g., print media, audio, moving picture, unpublished production material), the find existing ID function 32 enables retrieving an existing unique identifier related to the media from different existing institutional databases such as ISAN, ISBN, ISRC, UMID. If an existing identifier related to the media is found, this found identifier will be also stored in the media information database 16 as a unique external identifier of the media.

The create function 34 enables adding a new media with its associated information (resulting from the consolidation engine 14 or from other application servers 18) in the media information database 16.

The modify function 36 enables enriching pertinent information (resulting from the consolidation engine 14 or from other application servers 18) related to an existing media stored in the media information database 16.

The remove function 38 removes a media that no longer includes associated information from the media information database 16.

The media access function 40 can be accomplished with the unique internal identifier or the associated external identifier (which corresponds to an ISAN, UMID or ISBN identifier). If the media does not exist, it is created with a new unique internal identifier in the media information database 16, and an external identifier (found in the ISAN database 42, the UMID database 44, or the ISBN database 46) can be also associated with the media.

Note that the other application servers 18 can also access or/and enrich the media information database 16 by using the create/modify/remove/access functions or by directly accessing specific consolidated results from the consolidation engine 14 in order to enrich a given media.

FIG. 3 is an example of a statistical correlation matrix from the consolidation engine 14. Media1 can be implicitly enriched by the following information: <Neo> and <phone> are contained in the media and it can be associated with a <Matrix> film. There is no specific information related to Media2 or MediaN.

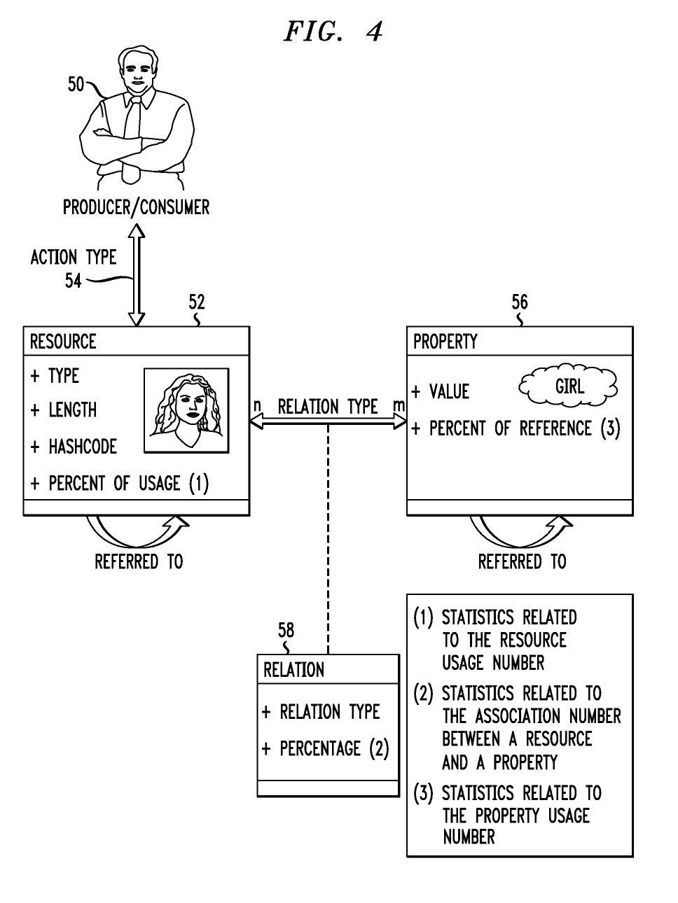

FIG. 4 illustrates an exemplary media usage model that enables the extraction of pertinent information from implicit user actions on media using a statistical engine. The model includes at least one each of the following elements: a producer/consumer 50, a resource 52, an action type 54, a property 56, and a relation 58.

The producer/consumer 50 is any entity that interacts with the Resource 52. There are at least two types of entities here: media producers (humans, device types like scanners) and media consumers (humans).

The resource 52 is a numeric media type (e.g., an image, a video, an audio, a document) or a media container type (e.g., a directory, a Web site).

An action type 54 represents any interaction between a resource 52 and a producer/consumer 50. It can be, for example, uploading or downloading a resource from a Web site, saving/removing/moving a resource, opening a resource, sending a resource, or tagging or commenting a resource.

A property 56 is any pertinent information related to a resource 52. A property value can be a resource type, an associated URL, a directory name, a filename, associated tags or associated resources.

A relation 58 is an information type (such as a directory name, a filename, URLs, resource associations, tags) that links a resource 52 to a property 56. A relation type can be, for example: “is in directory”, “has filename”, or “has tag”.

An algorithm for building pertinent information from user actions on media takes into account the structural, temporal nature and also the combination of the following non-exhaustive list of criteria.

The co-occurrence technique (from user actions analysis) is used for creating a network with weighted links. Each time a user action related to a resource generates implicit information (e.g., a directory name, a filename, a URL, an association to other resources), the weight of the edge between the corresponding nodes is increased by a certain factor. If it is the first time, an edge is created with a weight x, else the edge weight is increased by y.

An evaporated factor is used for adding time-based information to the weights of the edges in a graph. Each time the graph has been updated after a user action related to a resource 52, the weight of each edge impacted by the resource 52 in the graph is slightly recalculated.

Performance issues are also taken into account. As shown in FIG. 4, a resource (Photo1, Video1) may potentially be associated with a lot of pertinent information (e.g., associated with other properties or other resources). Therefore, different statistical calculations may be used.

In the case of convergence with a social tagging graph, an algorithm for building a hierarchy of tags from the implicit data is taken into account. See, for example, “Collaborative Creation of Communal Hierarchical Taxonomies in Social Tagging Systems,” by Paul Heymann and Hector Garcia-Molina, InfoLab Technical Report 2006-10. If there is no convergence, heuristic functions are required to filter irrelevant information in order to avoid noise intentionally or randomly generated by users.

Correlation between implicit and explicit information may be used to enrich media content. A language mapping and synonyms dictionary is helpful to avoid data duplication related to a media. More complex ontology mapping could be also considered.

One example of a taxonomy consolidation algorithm that may be used is described below. It is to be understood that others may used in accordance with aspects of the present invention.

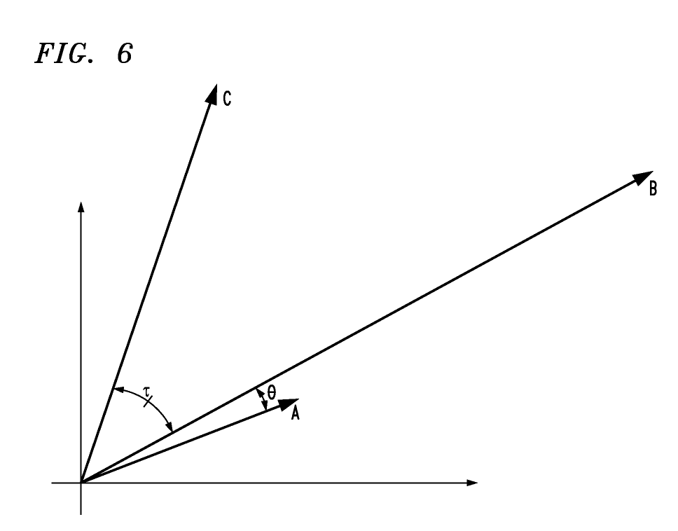

As shown in FIG. 6, similarity is independent of vector amplitude. Vector B is more similar to vector A than vector C, as the angle θ between vectors A and B is less than the angle T between vectors A and C.

Vector similarity may be represented as

$$sim ( A , B ) = \frac{A \cdot B}{{‖ A ‖}_{2} \times {‖ B ‖}_{2}}$$

Vector preponderance order may be represented as

$$A = ( \begin{matrix}{a}_{1} \\ … \\ {a}_{n}\end{matrix} )$$

$${‖ A ‖}_{1} = {\sum }_{i = 0}^{n} \vert {a}_{i} \vert$$

Set forth below is an example Vector Similarity Tree Algorithm:

| | |
|---|---|
| 000 | Gt=<null, root> |
| 001 | for each A in VectorSet |
| 002 | maxCandidateSim=0; |
| 003 | maxCandidate=root; |
| 004 | for each B in getVerticle(Gt) |
| 005 | if sim(A, B) > maxCandidateSim |
| 006 | maxCandidateSim=sim(A, B) |
| 007 | maxCandidate=B |
| 008 | end if |
| 009 | end for |
| 010 | if maxCandidateSim<taxThreshold |
| 011 | Gt=Gt U <maxCandidate, A> |
| 012 | else |
| 013 | Gt=Gt U <root, A> |
| 014 | end if |
| 015 | end for |

000 and 004: Give definition of taxonomy tree (Gt). <A, B> represents a verticle between vector A and vector B, Gt is the set of verticle of the taxonomy tree, and getverticle returns the list of vectors already in the taxonomy tree.

001: It is assumed that VectorSet is ordered by preponderance. The first is the most preponderant the last is the least. Definition of preponderance in norm one.

002 and 003: Max similarity and corresponding vector found in vectors of the taxonomy.

004 to 009: Find the vector of Gt that is the most similar to “B”

010, 011: If the most similar vector is similar enough, then “B” is added in a branch below that vector (B is a specialized concept of “maxCandidate”).

013: A new conceptual branch is created as B is not similar to other concept in the tree.

Note that an iMK (Implicit Media Knowledge) vector is defined by its coordinate in a base of resource. A resource can be a media file or a property (when a property tags another one). By way of example, let us look at “c:\movies\scifi\matrix.avi”, where “c” is a property that tags the resource “movies”, “movies” is a property that tags the resource “scifi”, and “scifi” is a property that tags the raw resource “matrix.avi”. The vector space of this single example contains three resources, “movies”, “scifi”, and “matrix.avi”.

An iMK vector is a textual property (e.g., matrix). iMK coordinates represent for each resource the number of times that text is associated with a resource. iMK preponderance (in norm one) measures the number of times the text has been used to qualify a resource or another property. iMK similarity measures in proportion how much a property is associated to a set of resource is comparable to another one.

Here is an example:

$${\to }_{SciFi} = ( \begin{matrix}3 \\ 2 \\ 0\end{matrix} ) , {\to }_{Movies} = ( \begin{matrix}6 \\ 6 \\ 6\end{matrix} )$$

3 resources: “matrix.avi”, “total_recall.avi” and “bridget_jones.avi”
“scifi” has been associated 3 times with “matrix.avi”; 2 times with “total_recall.avi”; and 0 times with “bridget_jones.avi”
“Movies” has been associated 6 times with “matrix.avi” and “total_recall.avi” and 4 times for “bridget_jones.avi”

“Movies” is more preponderant than “SciFi” so it is intuitively the most abstract concept. The similarity between “Scifi” and “Movies” is 0,8. So the two concepts are relatively similar (if taxThreshold is less than 0,8). In that case, the taxonomy tree will contain a branch
(ROOT)→(Movies)→(SciFi)

It is also noted that the end-user will need to install the software on their computer in spite of certain privacy issues. It is therefore advisable that the end-user be able to locally visualize media log contents that will be used for the implicit indexing media. The end-user may then feel better by seeing that logs are only focused on media. A tool for visualizing/modifying implicit media knowledge can be also delivered to motivate users to install the system on their computers. Other tools that integrate high-scores, games or/and bonuses can also be delivered to motivate users to install the software.

Further, statistical calculations are only periodically performed in batch mode because this has a significant impact on performance. But when the server 4 receives millions of logs from computers, clustered machines should be deployed on the server side for load sharing.

At the software security level, there is no sensitive information like the user's password in logs: the media file content (“rid_hash”) and the computer's IP address (“uid_hash”) have been encrypted using MD5 Hash Code calculation, as shown in the media log format below:

<?xml version=”1.0” encoding=”Windows-1252”?>
<log uid_hash=”d3ca7eafaefdf23c6959cba5ed8c422c”
rid_hash=”49bf41d6e11d0948112b667db768f758”
rid_type=”jpg” rid_size=”66287”>
<content_type=”OPEN_FILE”
value=”c:\\WINNT\Web\Wallpaper\Autumn.jpg”/>
</log>

The security problem remains at the operating system level because the present invention uses Hypertext Transfer Protocol (HTTP), which is not secured for transporting log data from the client 2 to the server 4. Currently, one solution is to temporarily (during several hours) filter inconsistent logs provided by some computers (via their IP addresses) if suspicious logs or attacks are detected. However, if the need arises, it may be possible to encrypt the logging communications using a separate protocol such as Secure Sockets Layer (SSL) based on randomly generated passwords.

Portions of the present invention and corresponding detailed description have been presented in terms of software, or algorithms and symbolic representations of operations on data bits within a computer memory. Such descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system or server, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a flash drive or a hard drive) or optical (e.g., a CD or DVD), and may be read only or random access. Similarly, the transmission medium may be twisted wire pairs, coaxial cable, optical fiber, or some other suitable transmission medium known to the art. The invention is not limited by these aspects or of any given implementation.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. In a telecommunications network, an apparatus for tracking and correlating user actions on electronic media, the apparatus comprising:
a media action logs database that stores all media action logs related to any media received from a client via a telecommunications device;
a consolidation engine that correlates according to statistical criteria implicit user actions on media to extract information associated with a given media;
a media information database that stores all media enriched by pertinent information resulting from the consolidation engine, wherein each stored media can be retrieved with a unique identifier number; and
at least one application server that can access and enrich information related to media stored in the media information database.

2. The apparatus of claim 1, wherein types of implicit user actions on media that are recorded on the media action logs include downloading, uploading, storing, sending, copying, moving, modifying, displaying, and/or URL associating the media.

3. The apparatus of claim 1, wherein each media access log includes at least one of a resource unique ID, a resource type, an external resource unique ID, a log type, and a log value.

4. The apparatus of claim 1, further comprising:
a collect media action logs component that collects all media action logs from the client;
a media information management component that manages media resulting from the consolidation engine.

5. The apparatus of claim 1, wherein for each media the media information management component is adapted to perform at least one of the following functions: find existing ID, create, modify, remove, and/or access.

6. The apparatus of claim 5, wherein:
the find existing ID function enables retrieving an existing unique identifier related to the media from different existing institutional databases;
the create function enables adding a new media with its associated information resulting from the consolidation engine or from other application servers in the media information database;
the modify function enables enriching pertinent information resulting from the consolidation engine or from other application servers related to an existing media stored in the media information database;
the remove function removes a media that no longer includes associated information from the media information database;
the media access function is accomplished with the unique internal identifier or the associated external identifier.

7. In a telecommunications network, a method of tracking and correlating user actions on electronic media via a media action data server, the method comprising:
collecting media action logs received from a client;
storing all user action logs related to any media received from the client in a media action logs database;
correlating according to statistical criteria implicit user actions on media to extract information associated with a given media;
storing all media enriched by pertinent information resulting from the consolidation engine in a media information database, wherein each stored media can be retrieved with a unique identifier number; and
managing media resulting from the consolidation engine.

8. The method of claim 7, wherein types of implicit user actions on media that are recorded on the media action logs include downloading, uploading, storing, sending, copying, moving, modifying, displaying, and/or URL associating the media.

9. The method of claim 7, wherein each media access log includes at least one of a resource unique ID, a resource type, an external resource unique ID, a log type, and a log value.

10. The method of claim 7, wherein for each media the media information management component is adapted to perform at least one of the following functions: find existing ID, create, modify, remove, and/or access.

11. The method of claim 10, wherein:
the find existing ID function enables retrieving an existing unique identifier related to the media from different existing institutional databases;
the create function enables adding a new media with its associated information resulting from the consolidation engine or from other application servers in the media information database;
the modify function enables enriching pertinent information resulting from the consolidation engine or from other application servers related to an existing media stored in the media information database;
the remove function removes a media that no longer includes associated information from the media information database;
the media access function is accomplished with the unique internal identifier or the associated external identifier.

12. A computer program product comprising:
a computer-usable data carrier storing instructions that, when executed by a computer in a telecommunications network, cause the computer to perform a method comprising:
collecting media action logs received from a client;
storing all user action logs related to any media received from the client in a media action logs database;
correlating according to statistical criteria implicit user actions on media to extract information associated with a given media;
storing all media enriched by pertinent information resulting from the consolidation engine in a media information database, wherein each stored media can be retrieved with a unique identifier number; and
managing media resulting from the consolidation engine.

13. The computer program product of claim 12, wherein types of implicit user actions on media that are recorded on the media action logs include downloading, uploading, storing, sending, copying, moving, modifying, displaying, and/or URL associating the media.

14. The computer program product of claim 12, wherein each media access log includes at least one of a resource unique ID, a resource type, an external resource unique ID, a log type, and a log value.

15. The computer program product of claim 12, wherein for each media the media information management component is adapted to perform at least one of the following functions: find existing ID, create, modify, remove, and/or access.

16. The computer program product of claim 15, wherein:
the find existing ID function enables retrieving an existing unique identifier related to the media from different existing institutional databases;
the create function enables adding a new media with its associated information resulting from the consolidation engine or from other application servers in the media information database;
the modify function enables enriching pertinent information resulting from the consolidation engine or from other application servers related to an existing media stored in the media information database;
the remove function removes a media that no longer includes associated information from the media information database;
the media access function is accomplished with the unique internal identifier or the associated external identifier.

17. A media ID card for centralizing all pertinent information related to a media, wherein the media ID card includes enriched information obtained from a consolidation engine that collects descriptive metadata and a history of implicit actions performed on the media by users and a plurality of links with other media and users.

18. The media ID card of claim 17, wherein types of implicit user actions on media include downloading, uploading, storing, sending, copying, moving, modifying, displaying, and/or URL associating the media.
